(19) United States
(12) Patent Application Publication
(10) Pub. No.: US 2006/0085577 A1
(43) Pub. Date: Apr. 20, 2006

(54) Portable recording and reproducing apparatus, recording and reproducing system and recording and reproducing method

(75) Inventors: Kazuhiro Takashima, Tokyo (JP); Hidehito Izawa, Hanno-shi (JP); Toshihiro Morohoshi, Kawasaki-shi (JP); Masao Iwasaki, Fuchu-shi (JP); Kiyoshi Hoshino, Ome-shi (JP); Hitoshi Suzuki, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/241,973

(22) Filed: Oct. 4, 2005

(30) Foreign Application Priority Data
Oct. 14, 2004 (JP) 2004-300315

(51) Int. Cl. G06F 13/38

(52) U.S. Cl. 710/62

(57) ABSTRACT

A portable recording and reproducing apparatus has a power supply unit configured to receive a direct current from an external power supply device C and charge a built-in battery with the direct current to supply electricity to respective units, an input unit configured to receive an instruction signal for instructing acquisition of content information from the external power supply device, a recording unit configured to record the content information in a recording area, a communication unit configured to communicate with an external device so as to acquire content information, and a control unit configured to, when receiving the instruction signal from the input unit, control to request the external device to transfer the content information through the communication unit, acquire the content information, record the content information in the recording unit, and read out and reproduce the content information from the recording unit.

### CROSS-REFERENCE TO RELATED APPLICATIONS

This application is based upon and claims the benefit of priority from prior Japanese Patent Application No. 2004-300315, filed Oct. 14, 2004, the entire contents of which are incorporated herein by reference.

### BACKGROUND OF THE INVENTION

1. Field of the Invention

The present invention relates to a portable recording and reproducing apparatus, and more particularly, to a portable recording and reproducing apparatus using a cradle, and a recording and reproducing method.

2. Description of the Related Art

Recently, processing of audio information and the like as digital data has been generalized, and in particular, portable recording and reproducing apparatuses have been manufactured and spreading. Because such a portable recording and reproducing apparatus enables music to be enjoyed without any other particular means and audio information to be operated in the unit of a file, its access performance is tremendously higher than a conventional apparatus.

Patent document 1 (Jpn. Pat. Appln. KOKAI Publication No. 2001-189050) describes the operation of such a portable recording and reproducing apparatus in detail, which can handle a large amount of audio information and the like in cooperation with a personal computer.

However, the conventional portable recording and reproducing apparatus needs to be charged frequently for usage, and it is an object to be achieved to make easy a complicated operation for charging. As a jig for this purpose, -a cradle has been well known. Although optimum charging operation is executed if the portable recording and reproducing apparatus is stored in the cradle after a user goes back to home, there is a problem that any other operations are not indicated evidently.

### BRIEF SUMMARY OF THE INVENTION

One embodiment of the present invention is a portable recording and reproducing apparatus comprising: a power supply unit configured to receive a direct current from an external power supply device and charge a built-in battery with the direct current to supply electricity to respective units; an input unit configured to receive an instruction signal for instructing acquisition of content information from the external power supply device; a recording unit configured to record the content information in a recording area; a communication unit configured to communicate with an external device; and a control unit configured to, when receiving the instruction signal from the input unit, control to request the external device to transfer the content information through the communication unit, acquire the content information, record the content information in the recording unit, and read out and reproduce the content information from the recording unit.

### BRIEF DESCRIPTION OF THE SEVERAL VIEWS OF THE DRAWING

FIG. 1 is a block diagram showing an example of a configuration of a portable recording and reproducing apparatus, a cradle, and a personal computer according to an embodiment of the present invention;

FIG. 2 is an appearance view showing an example of the portable recording and reproducing apparatus, cradle and personal computer according to the embodiment of the invention;

FIG. 3 is an appearance view showing an example of the configuration of the portable recording and reproducing apparatus, cradle and personal computer according to the embodiment of the invention;

FIG. 4 is a block diagram showing another example of the configuration of the portable recording and reproducing apparatus, cradle and personal computer according to the embodiment of the invention;

FIG. 5 is a flow chart showing an example of transfer processing from a hard disk of the portable recording and reproducing apparatus according to the embodiment of the invention;

FIG. 6 is a flow chart showing an example of transfer processing from an optical disk of the portable recording and reproducing apparatus according to the embodiment of the invention;

FIG. 7 is a flow chart showing an example of another example of the transfer processing from the hard disk of the portable recording and reproducing apparatus according to the embodiment of the invention; and

FIG. 8 is a flow chart showing another example of the transfer processing from the optical disk of the portable recording and reproducing apparatus according to the embodiment of the invention.

### DETAILED DESCRIPTION OF THE INVENTION

Hereinafter, one embodiment of the present invention will be described in detail with reference to the accompanying drawings.

<Recording and Reproducing Apparatus According to One Embodiment of the Invention>

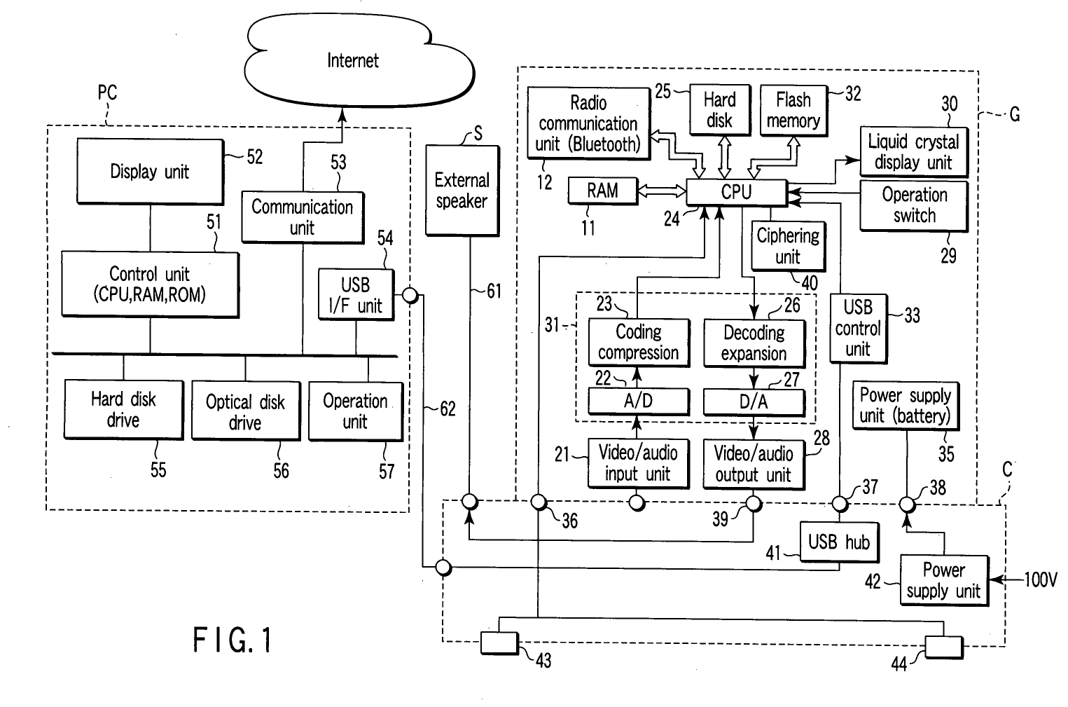

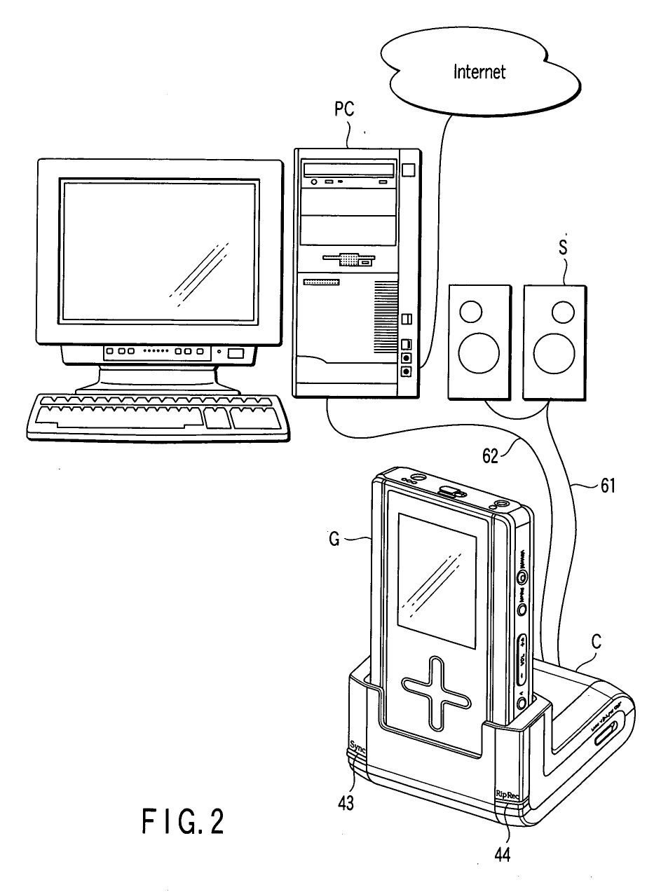

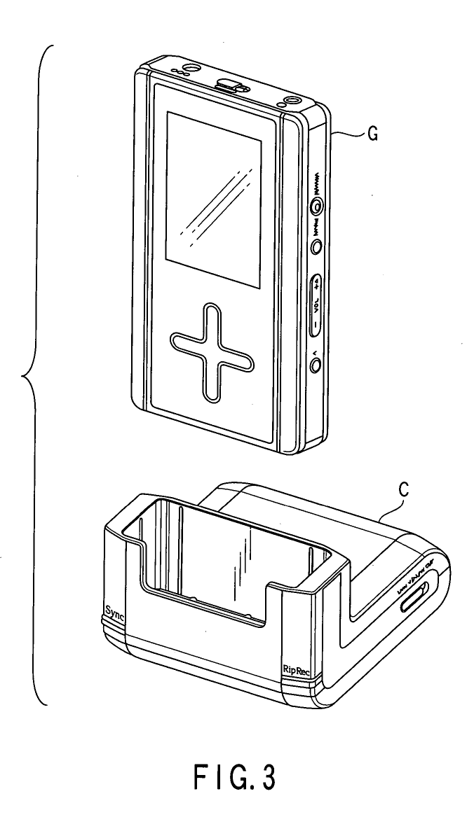

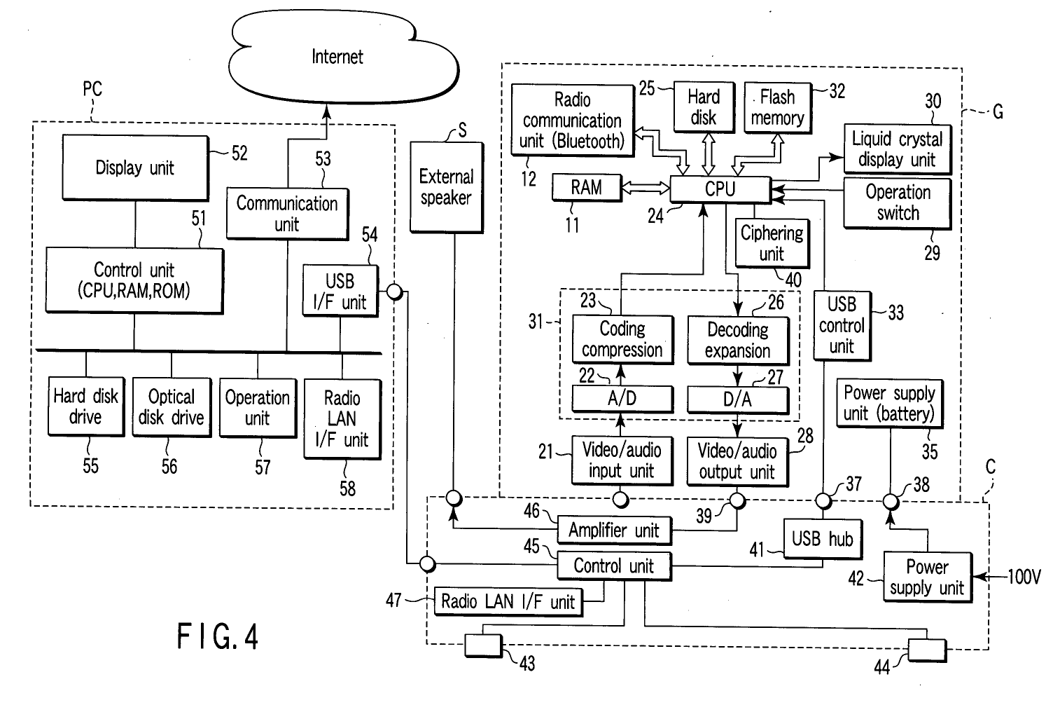

Hereinafter, a recording and reproducing apparatus according to one embodiment of the invention will be described in detail with reference to the accompanying drawings. FIG. 1 is a block diagram showing an example of a configuration of the portable recording and reproducing apparatus, cradle and personal computer according to the embodiment of the invention. FIG. 2 is an appearance view showing an example of the portable recording and reproducing apparatus, cradle and personal computer. FIG. 3 is an appearance view showing an example of the configuration of the portable recording and reproducing apparatus, cradle and personal computer. FIG. 4 is a block diagram showing another example of the configuration of the portable recording and reproducing apparatus, cradle and personal computer.

As shown in FIGS. 1 to 3, a portable recording and reproducing apparatus G according to the embodiment of the invention comprises a video/audio processing integrated device 31, which is connected to a video/audio input unit 21 and a video/audio output unit 28, a CPU 24 which is a central processing unit or a control unit to be connected to the integrated device 31, a RAM 11 which is a memory area to be connected the CPU 24, a hard disk 25 which is connected to the CPU 24, a flash memory 32 which is an incorporated memory area to be connected to the CPU 24, a ciphering unit 40 which carries out ciphering processing on content information, a liquid crystal display unit 30 for displaying operation information and the like, the display unit 30 being connected to the CPU 24, an operation switch 29 to be connected to the CPU 24, a USB control unit 33, a USB terminal 37 and a power supply unit 35.

An operation switch 29 and a liquid crystal display unit 30 are connected to the micro processor 24. The operation switch 29 has switches for operation inputs for audio recording, video recording, audio/video reproduction and operation power OFF, of the portable recording and reproducing apparatus G. The liquid crystal display unit 30 indicates the operating state of the portable recording and reproducing apparatus G in accordance with input from the operation switch 29.

An A/D circuit 22, a coding compression circuit 23, a decoding expansion circuit 26 and a D/A circuit 27 are constituted of the 1-chip video/audio processing integrated device (hereinafter referred to as video/audio processing IC) 31.

Further, the portable recording and reproducing apparatus G includes a radio communication unit 12, which is an interface for short range radio communication such as Bluetooth, the radio communication unit 12 being connected to the CPU 24. The Bluetooth mentioned here refers to interface standard for short range radio communication of about 10 m, and its maximum communication speed is 1 Mbit/second. The Bluetooth uses a frequency in the same 2.4 GHz band as IEEE802.11b type radio LAN.

The radio communication unit 12 is not restricted to Bluetooth but may be of any type as long as it is similar short range radio communication. Although UWB standard, infrared ray communication standard, radio LAN (IEEE802.11b) standard and the like are preferable, the present invention is not restricted thereto.

As electric connecting terminals when accommodated in the cradle C, the portable recording and reproducing apparatus G comprises at least an input terminal 36 for receiving a first acquisition instruction signal from a Sync switch 44 and a second acquisition instruction signal from a Riprec switch 45, a video/audio output terminal 39 connected to the video/audio output unit 28, and a power input terminal 38 to be connected to the power supply unit 35.

As shown in FIGS. 1 to 3, the cradle C as a power supply device has a USB hub 41 to be connected to the USB terminal 37. The cradle C further comprises the Sync switch 44 for generating a trigger signal as an instruction signal for transfer processing (synchronous processing) and the Riprec switch 45 for generating a trigger signal as an instruction signal for transfer processing of a CD drive or the like of the personal computer. In the transfer processing, a directory of a hard disk or the like of the personal computer has the same content as a predetermined directory of the hard disk 25 of the portable recording and reproducing apparatus G. Further, the cradle C has a power supply unit 42 which converts household alternate current AC 100 V to, for example, direct current DC 12 V, and supplies the direct current to the power supply unit (battery) 35 of the portable recording and reproducing apparatus G through the power input terminal 38.

The portable recording and reproducing apparatus G of the present invention, as shown in FIGS. 1 and 3, is connected to the personal computer PC through the cradle C with a USB cable 62 or the like. The personal computer PC as an external device storing content information therein (as viewed from the portable recording and reproducing apparatus G) has a control unit 51 containing a CPU, and a RAM, a ROM and the like for storing various kinds of operation programs, a display unit 52 such as a liquid crystal display, a hard disk drive 55 for storing content information such as audio information, an optical disk drive 56 such as a compact disc (CD) and a digital versatile disc (DVD), an operating unit 57 such as a keyboard, an I/F unit 54 such as USB, and a communication unit 53 which enables connection to Internet like IEEE802 through a data bus. As shown in FIG. 4, preferably, the personal computer has the radio I/F unit 58 such as IEEE802.11b.

Preferably, the cradle C as a power supply device includes an amplifier unit 46, a control unit 45 having a CPU, a ROM and the like, a radio LAN I/F unit 47, and the like. At this time, it is possible to acquire content information by requesting directly to the personal computer without transferring an instruction signal for synchronous processing or transfer processing to the portable recording and reproducing apparatus G.

The portable recording and reproducing apparatus G of the invention executes following reproduction processing with such a configuration. In the portable recording and reproducing apparatus G, digital coded compressed data, which is read out from the hard disk 25 or the incorporated flash memory 32 in accordance with operation information given from the operation switch 29 depending on an operation mode basically given as an initial setting under a control of the micro processor 24, is expanded at the decoding expansion circuit 26 and decoded to be converted to a digital video/audio signal. The digital video/audio signal generated by this decoding expansion circuit 26 is converted to an analog video/audio signal by means of the digital/analog conversion circuit (hereinafter referred to as D/A circuit) 27, and supplied to the video/audio output circuit 28 constitute of an amplifying circuit and a speaker or a display so as to carry out the reproduction processing.

Further, basically, the portable recording and reproducing apparatus G as a recording and reproducing apparatus of the invention executes record processing corresponding to an operation mode given as an initial setting. That is, digital content information (or analog content information in case of through the video/audio input unit 21) acquired through the USB terminal 37 (or the video/audio input unit 21 or the like) in accordance with the operation information given from the operation switch 29 is ciphered by the ciphering unit 40 and recorded in the hard disk 25 or the flash memory 32. The operation information in such processing is given by user's operating the operation switch 29 (including a remote controller) provided on the portable recording and reproducing apparatus G. However, as described later, such information may be given from the cradle, personal computer or the like through the USB terminal 45 or the radio communication unit 12.

The portable recording and reproducing apparatus G as a recording and reproducing apparatus of the invention executes reproduction processing corresponding to its operation mode basically given as an initial setting. It is also possible to execute edition processing following operation information given from the operation switch 29 or with reference to digital data read out from the incorporated flash memory 32. The operation information in such a processing is given by user's operating the operation switch 29 (including a remote controller) provided on the portable recording and reproducing apparatus G. However, as described later, such information may be give from the cradle, personal computer or the like through the USB terminal 45 or the radio communication unit 12.

<Synchronous Processing/Transfer Processing Corresponding to Switch of Cradle>

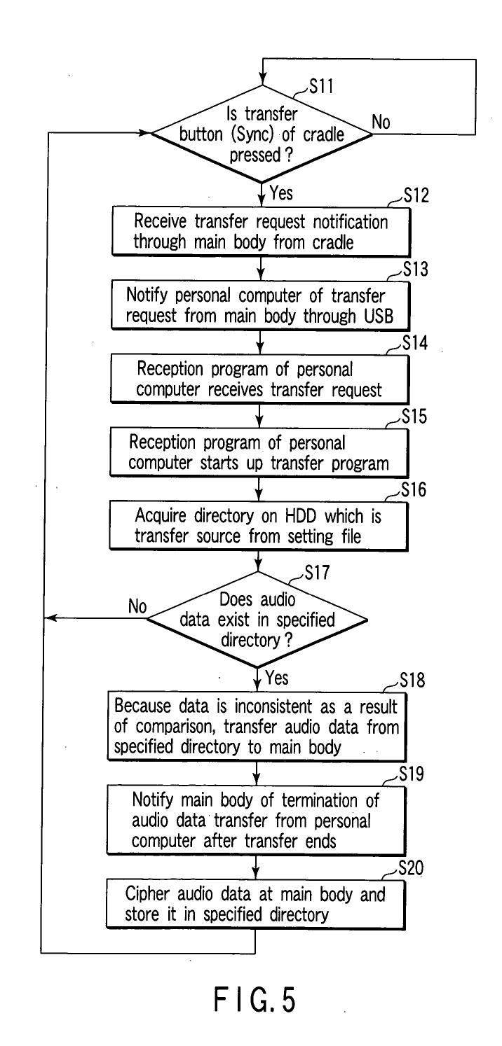

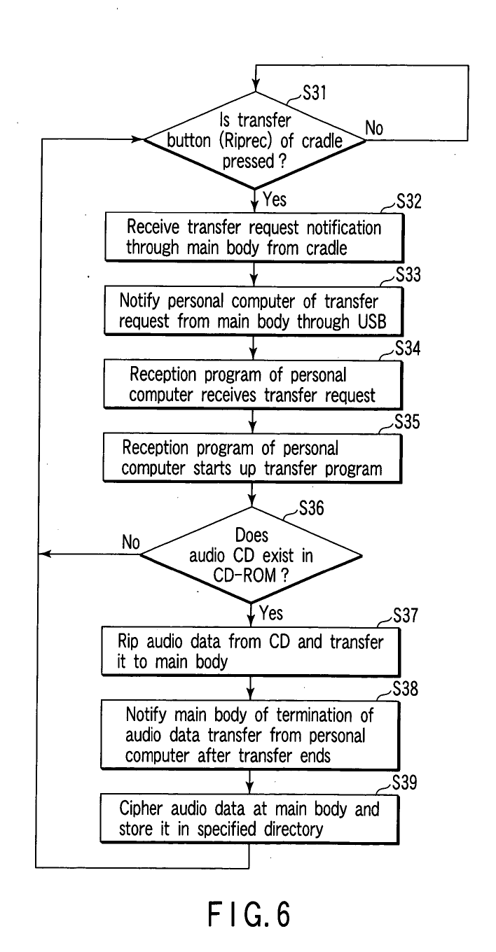

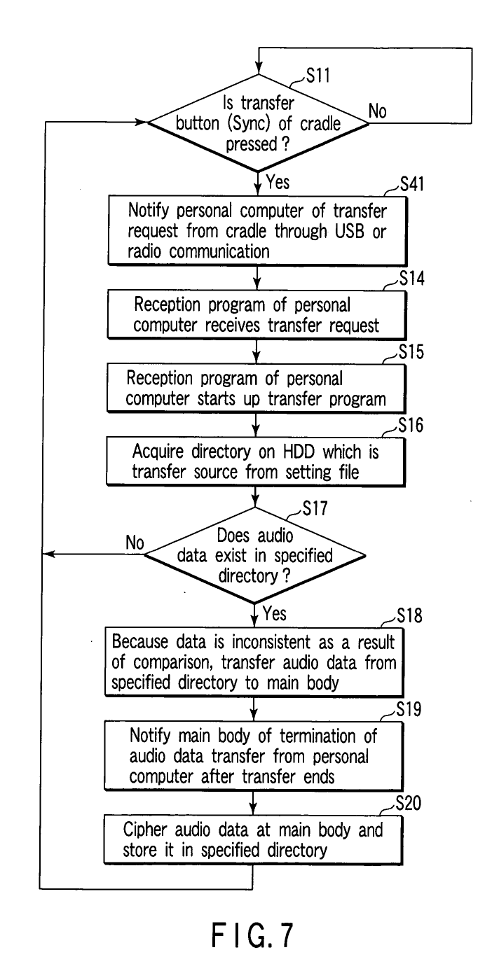

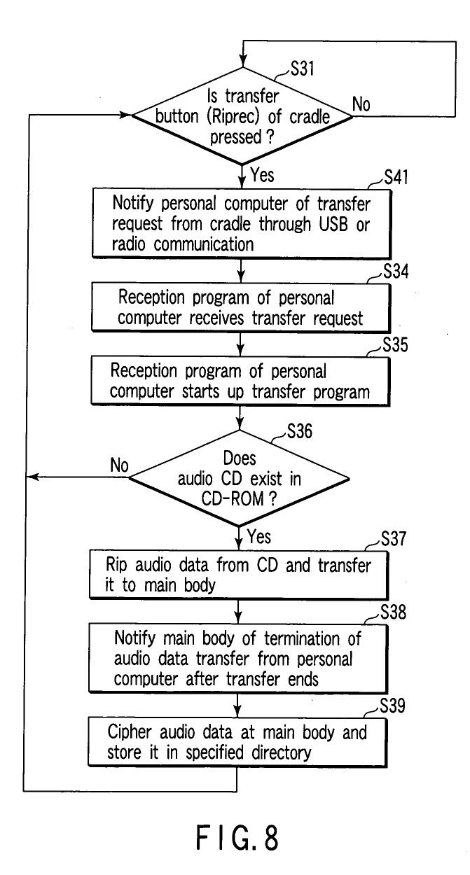

Next, the synchronous processing/transfer processing corresponding to the switch of the cradle will be described with reference to a flow chart. FIG. 5 is a flow chart showing an example of the synchronous processing with a hard disk of the portable recording and reproducing apparatus according to the embodiment of the invention. FIG. 6 is a flow chart showing an example of the transfer processing form an optical disk of the portable recording and reproducing apparatus. FIG. 7 is a flow chart showing another example of the synchronous processing with the hard disk of the portable recording reproducing apparatus. FIG. 8 is a flow chart showing another example of the transfer processing from the optical disk of the portable recording and reproducing apparatus.

Synchronous Processing

The portable recording and reproducing apparatus G of the invention executes transfer processing between a predetermined directory of the hard disk drive 55 of a recording device such as a personal computer connected with USB and a predetermined directory of the hard disk drive 55 in the portable recording and reproducing apparatus G by using, for example, the Sync switch 44 or the like attached to the cradle, and further executes the synchronous processing so as to obtain the same content as a result of comparison processing. Hereinafter, the processing procedure will be described with reference to the flow chart.

According to the flow chart of FIG. 5, first, the portable recording and reproducing apparatus G is stored in the cradle C, and with the portable recording and reproducing apparatus G activated, the user presses the synchronous switch 44 of the cradle C (S11). As a result, the cradle C supplies a transfer request signal to the main body of the portable recording and reproducing apparatus G through the input terminal 36 (S12). Then, the portable recording and reproducing apparatus G requests the personal computer PC to transfer the supplied signal through the USB control unit 33, the USB terminal 37, the USB hub 41, and the USB cable 62 under a determination of the CPU 24 or the like (S13).

Correspondingly, in the personal computer PC, its reception program receives a transfer request (S14) and the reception program starts a transfer program (S15). Next, a directory on the hard disk drive 55 which is a transfer source is obtained from a setting file (S16). In the meantime, preferably, the directory at the time of this synchronous processing or the transfer processing described later is set in advance by operating the personal computer PC or the portable recording and reproducing apparatus G, or an appropriate directory is specified by initial setting.

If audio information exists on the directory on the hard disk drive 55 (S17), the contents and dates of both the directories are compared. As for content information not matching, content information such as audio information is transferred from the specified directory to the portable recording and reproducing apparatus through USB (S18). Then, after the transfer is ended, termination of transfer of the audio information is notified from the personal computer PC to the portable recording and reproducing apparatus G (S19). Further, the portable recording and reproducing apparatus G ciphers the audio information (content information) by, for example, the ciphering unit 40 and stores it in the hard disk 25 (S20). The CPU 24 of the portable recording and reproducing apparatus G reads out it to decode and expand a reproduction signal, and outputs the signal through the video/audio output unit 28, the video/audio output terminal 39 or the like. At this time, as shown in the cradle of FIGS. 1 and 4, it is preferable to reproduce sound from an external speaker S by connecting a connection cord.

According to the portable recording and reproducing apparatus G of the invention, instruction of the transfer of content information or the like to the personal computer is carried out by operation from the cradle C or the like. Therefore, the configuration of audio information or the like currently in the hard disk can be transferred to a player or the portable recording and reproducing apparatus G, intuitively and easily in a moment.

As shown in the flow chart of FIG. 7, the portable recording and reproducing apparatus G has the control unit 45 shown in FIG. 4. Preferably, the cradle C having a determination function determines a transfer instruction (synchronous instruction) from the Sync switch 44 without bringing back to the portable recording and reproducing apparatus G for itself as described in step S41, and instructs the personal computer PC to transfer by using a communication function such as a radio LAN.

Transfer Processing

Further, the portable recording and reproducing apparatus G of the invention executes transfer processing for transferring content information such as audio information of the CD (or DVD in case of animation) stored in the optical disk drive of the recording device of the personal computer connected through USB or the like to a desired directory of the hard disk drive 25 easily by using, for example, the Riprec switch 45 attached to the cradle C or the like. Hereinafter, the processing procedure will be described with reference to a flow chart.

According to the flow chart of FIG. 6, first, the portable recording and reproducing apparatus G is stored in the cradle C, and with the portable recording and reproducing apparatus G activated, the Riprec switch 45, which is a transfer switch of the cradle C, is pressed by the user (S31). Consequently, a transfer request signal is supplied to the main body of the portable recording and reproducing apparatus G through the input terminal 36 from the cradle C (S32). Then, the portable recording and reproducing apparatus G makes a transfer request to the personal computer PC through the USB control unit 33, the USB terminal 37, the USB hub 41, and the USB cable 62 under a determination of the CPU 24 or the like (S33).

Correspondingly, in the personal computer PC, its reception program receives a transfer request (S34) and the reception program starts the transfer program (S35). Next, if there is content information such as audio information in the CD-ROM drive (or DVD drive) 56 or the like (S36), the audio information is ripped from a specified directory of the CD-ROM drive 56 and transferred to the portable recording and reproducing apparatus through the USB (S37). After the transfer ends, termination of transfer of the audio information is notified from the personal computer PC to the portable recording and reproducing apparatus G (S38). Further, the portable recording and reproducing apparatus G ciphers the audio information (content information) by, for example, the ciphering unit 40 and stores it in the hard disk 25 (S39). The CPU 24 of the portable recording and reproducing apparatus G reads out it to demodulate and expand the reproduction signal, and then outputs the signal from the video/audio output unit 28, the video/audio output terminal 39 or the like.

According to the portable recording and reproducing apparatus G of the invention, the transfer of the content information or the like to the personal computer or the like is instructed by operation from the cradle C or the like. Therefore, the user can transfer audio information or video information of a CD or DVD easily and intuitively to a player, which is the portable recording and reproducing apparatus G in a moment, like the above-described synchronous processing.

As shown in the flow chart of FIG. 8, the control unit 45 or the like shown in FIG. 4 is provided, and the cradle C having a determination function, preferably, determines a transfer instruction from the Riprec switch 45 for itself without returning it to the portable recording and reproducing apparatus G, as described in step S41 and then, instructs the personal computer PC to transfer by using the communication function such as the USB cable 62 and radio LAN.

### ANOTHER EMBODIMENT

As well as the above-described embodiment, a following embodiment can be executed. That is, the synchronous processing and transfer processing of the above embodiment do not always have to be carried out by means of the switch provided on the cradle C. Each processing is permitted to be carried out by pressing a switch provided on the main body of the portable recording and reproducing apparatus G (by pressing a special switch or plural switches).

A communication passage for the content information like the USB does not always have to pass through the USB hub 41 or the like of the cradle C, but it is permissible to connect the portable recording and reproducing apparatus G with the personal computer PC directly through a cable or radio.

If the personal computer PC is connected to Internet through the communication unit 53, preferably, album information is obtained from a CD to be ripped, and correspondingly, music information, artist information or the like or an image is obtained through Internet and transferred to the portable recording and reproducing apparatus G together with the audio information.

As for the content information, not only the above-described audio information, but also video information and other application information can be transferred. In this case, preferably, a ripping object is not only CD but DVD and other recording media.

Preferably, the personal computer PC contains a recording medium, or special reception and transfer programs are installed in the portable recording and reproducing apparatus G having a reproduction function for audio information stored in a detachable recording medium and used for a practical purpose.

The synchronous processing and transfer processing include, for example, in case of ripping from a CD, plural treatments such as acquisition of tag information from CDDB, ripping on a personal computer and transfer to PD after the ripping is completed. Therefore, in the synchronous processing and transfer processing, it is preferable to notify the portable recording and reproducing apparatus G of how far these plural steps are advanced each time to express a work process in the liquid crystal display unit 30.

In this case, it is so constructed that a command is exchanged between the portable recording and reproducing apparatus G and software of the personal computer PC, and the PC software returns a current status to the portable recording and reproducing apparatus G. As a consequence, the portable recording and reproducing apparatus G can notify the user that which music is being ripped or transfer to the portable recording and reproducing apparatus G is being carried out.

In case of executing some processings in succession, there is a state in which no problem occurs even when the USB connection is cut off (for example, during ripping from the personal computer) and there is a state in which data is destroyed if the USB connection is cut off (during file transfer to the PD). Accordingly, it is preferable to dispatch an alarm to inhibit disconnection depending on a current progress state on the display unit of the PD.

Although according to the embodiment, the USB is picked up as the transfer passage, it is permissible to use IEEE1394, wired LAN, radio LAN or the like.

When ripping from the CD, there can be a case where plural CD-ROM drivers are connected to the personal computer PC while an audio CD is stored in each driver. In this case, it is preferable to obtain a retrieval order of the CD-ROM drive (because it means a drive capable of reading audio CD here, DVD-ROM drive or another recording type CD or DVD drive is included) on a software for ripping on the side of the personal computer PC and display the retrieval order.

In this case, it is preferable to execute transfer processing by ripping from a drive accommodating an audio CD in the retrieval order or ripping data of all audio CDs accommodated in the drive connected to the personal computer PC successively in the retrieval order.

A case where plural players are connected to the portable recording and reproducing apparatus G can be considered. In this case also, it is preferable to store a device which sends a transfer request in a transfer software on the side of the personal computer PC if a transfer request occurs, so that the ripped audio information is transferred to that device.

According to the portable recording and reproducing apparatus G of the invention, an interface (for example, a switch) corresponding to an operation for requesting a content is provided on the cradle C which is a power supply device to be used for recharging in home or connecting to the personal computer PC. Consequently, the function can be added easily without adding physical interface such as buttons necessary for allocating this operation to the portable recording and reproducing apparatus G or a combination of physical interface operations (for example, pressing of plural keys, or a combination of continuous pressing of plural keys). It is also possible to avoid enlargement of the apparatus size due to increase of components without deteriorating the operability of a portable audio player. Further, it is preferable to set up a function for transferring any data on the personal computer PC by preparing plural buttons.

In the above-described portable recording and reproducing apparatus, as described above, if an instruction signal for instructing acquisition of content information generated depending on an operation of the switch or the like attached to the cradle is received through the input unit with the portable recording and reproducing apparatus stored in the cradle, which is an external power supply device, control is made to acquire the content information through the communication unit correspondingly.

Because the portable recording and reproducing apparatus is a portable device for reproducing audio information, the user stores it into the cradle for recharging when he/she comes home. The most easy operation for the user at this time is pressing a switch attached to the cradle. Preferably, the cradle is provided with this switch, and further, the portable recording and reproducing apparatus is provided with an input unit which receives an instruction signal generated corresponding to pressing of the switch, and a specified directory of a CD drive or hard disk in a personal computer relayed through the USB is accessed to acquire audio information or the like.

A directory of a acquisition destination or recording destination is set up preliminarily in the portable recording and reproducing apparatus or the personal computer. As a result, as for user's operation, by only pressing the switch of the cradle, audio information on a CD stored in the CD driver of the personal computer is automatically transferred to a desired directory of a hard disk incorporated in the portable recording and reproducing apparatus. Further, by providing plural switches, for example, setting one switch for a desired directory of the hard disk and the other switch for the CD drive, transfer operation of audio information or the like is further facilitated.

The present invention can be executed in various kinds of embodiments by those skilled in the art. Further, those skilled in the art can imagine various embodiments easily, and even if they are lack of inventive capability, they can apply the present invention to various embodiments. Therefore, the present invention extends to a wide range not inconsistent with a disclosed principle and novel features and is not restricted to the above-described embodiments.

What is claimed is:

1. A portable recording and reproducing apparatus comprising:
a power supply unit configured to receive a direct current from an external power supply device and charge a built-in battery with the direct current to supply electricity to respective units;
an input unit configured to receive an instruction signal for instructing acquisition of content information from the external power supply device, a recording unit configured to record the content information in a recording area;
a communication unit configured to communicate with an external device; and
a control unit configured to, when receiving the instruction signal from the input unit, control to request the external device to transfer the content information through the communication unit, acquire the content information, record the content information in the recording unit, and read out and reproduce the content information from the recording unit.

2. The portable recording and reproducing apparatus according to claim 1, wherein the instruction signal instructs to acquire the content information from an optical disk drive of the external device.

3. The portable recording and reproducing apparatus according to claim 1, wherein the instruction signal instructs to acquire the content information from a hard disk drive incorporated in the external device.

4. The portable recording and reproducing apparatus according to claim 1, wherein, by setting in advance a directory of an acquisition destination of the content information and a directory of a recording destination of the acquired content information in the recording unit, in the optical disk drive or the hard disk drive of the external device, the control unit, when receiving the instruction signal, controls to automatically acquire and record the content information without receiving any further instruction from a user.

5. The portable recording and reproducing apparatus according to claim 1, wherein, when a switch provided on the main body of the portable recording and reproducing apparatus is pressed, the control unit controls to instruct the external device to transfer the content information through the communication unit, acquire the content information, record the acquired content information in the recording unit, and read out and reproduce the recorded content information.

6. The portable recording and reproducing apparatus according to claim 1, wherein, the control unit, when receiving the instruction signal, requests the external device to transfer through the communication unit and controls the external device to acquire and transfer not only the content information but also information relating to the content information through a network.

7. The portable recording and reproducing apparatus according to claim 1, wherein the content information, which the control unit requests the external device for, is audio information or video information.

8. A recording and reproducing system comprising:
a power supply device having a converting unit configured to convert an alternate current to supply a direct current, and a switch unit configured to generate an instruction signal for instructing to acquire content information; and
a portable recording and reproducing apparatus having a main body to be stored in the power supply device detachably, the portable recording and reproducing apparatus including:
a power supply unit configured to receive the direct current from the converting unit of the power supply device and charge a built-in battery with the direct current to supply electricity to respective units;
an input unit configured to receive the instruction signal supplied from the switch unit of the power supply device;
a recording unit configured to record the content information in a recording area;
a communication unit configured to communicate with an external device; and
a control unit configured to, when receiving the instruction signal from the input unit, control to request the external device to transfer the content information through the communication unit, acquire the content information, record the content information in the recording unit, read out and reproduce the content information from the recording unit.

9. The recording and reproducing system according to claim 8, wherein the instruction signal instructs to acquire the content information from an optical disk drive of the external device.

10. The recording and reproducing system according to claim 8, wherein the instruction signal instructs to acquire the content information from a hard disk drive incorporated in the external device.

11. The recording and reproducing system according to claim 8, wherein, by setting in advance a directory of an acquisition destination of the content information and a directory of a recording destination of the acquired content information in the recording unit, in the optical disk drive or the hard disk drive of the external device, the control unit, when receiving the instruction signal, controls to automatically acquire and record the content information without receiving any further instruction from a user.

12. The recording and reproducing system according to claim 8, wherein communication of the communication unit between the recording and reproducing apparatus and the external device is carried out through a relay unit possessed by the power supply device.

13. The recording and reproducing system according to claim 8, wherein communication of the communication unit between the recording and reproducing apparatus and the external device is carried out between the recording and reproducing apparatus and the external device without through the power supply device.

14. A recording and reproducing system comprising
a recording device having an optical disk drive unit or a hard disk drive unit configured to record content information, and a communication function;
a power supply device having a relay unit configured to relay a signal from the recording device, a converting unit configured to convert an alternate current to supply a direct current, and a switch unit configured to generate an instruction signal for instructing acquisition of content information; and
a portable recording and reproducing apparatus having a main body to be stored in the power supply device detachably,
wherein the portable recording and reproducing apparatus has:
a power supply unit configured to receive the direct current from the converting unit of the power supply device and charge a built-in battery with the direct current to supply electricity to respective units;
an input unit configured to receive the instruction signal supplied from a switch unit of the power supply unit;
a recording unit configured to record the content information in a recording area;
a communication unit configured to communicate with the recording device by relaying through the relay unit of the power supply device so as to acquire the content information; and
a control unit configured to, when receiving the instruction signal from the input unit, control to request to transfer content information by communication with the recording unit through the communication unit and the relay unit, acquire the content information, record the content information in the recording unit, and read out and reproduce the content information.

15. The recording and reproducing system according to claim 14, wherein, when a first switch possessed by the switch unit of the power supply device is pressed, the control unit controls to acquire the content information from the optical disk drive of the recording device through the communication unit and the relay unit, and when a second switch possessed by the switch unit of the power supply device is pressed, the control unit controls to acquire the content information from the hard disk drive unit of the recording device through the communication unit and the relay unit.

16. A recording and reproducing method comprising:
with respect to a portable recording and reproducing apparatus comprising: a power supply unit configured to receive a direct current from an external power supply device and charge a built-in battery with the direct current to supply electricity to respective units; an input unit configured to receive an instruction signal for instructing acquisition of content information from the external power supply device; a recording unit configured to record the content information in a recording area; and a communication unit configured to communicate with the external device to acquire the content information,
controlling, when receiving the instruction signal from the input unit, to request the external device to transfer the content information through the communication unit, acquire that content information, record the content information in the recording unit, and read out and reproduce the content information.

17. The recording and reproducing method according to claim 16, comprising:
by setting in advance a directory of an acquisition destination of the content information and a directory of a recording destination of the acquired content information in the recording unit, in an optical disk drive or a hard disk drive of the external device, controlling, when the instruction signal is received, to automatically acquire and record the content information without receiving any further instruction from a user.

18. A recording and reproducing method comprising:
with respect to a recording and reproducing system comprising: a power supply unit having a converting unit configured to convert an alternate current to supply a direct current, and a switch unit configured to generate an instruction signal for instructing to acquire content information; and a portable recording and reproducing apparatus having a main body to be stored in the power supply device detachably, the portable recording and reproducing apparatus including: a power supply unit configured to receive the direct current from the converting unit of the power supply device and charge a built-in battery with the direct current to supply electricity to respective units; an input unit configured to receive the instruction signal supplied from the switch unit of the power supply device; a recording unit configured to record the content information in a recording area; and a communication unit configured to communicate with an external device so as to acquire the content information,
controlling, when the portable recording and reproducing apparatus receives the instruction signal from the input unit, to request the external device to transfer the content information through the communication unit, acquire the content information, record the content information in the recording unit, and read out and reproduce the content information from the recording unit.

19. The recording and reproducing method according to claim 18, comprising:
by setting in advance a directory of an acquisition destination of the content information and a directory of a recording destination of the acquired content information in the recording unit, in the optical disk drive or the hard disk drive of the external device, controlling, when the instruction signal is received, to automatically acquire and record the content information without receiving any further instruction from a user.

20. A recording and reproducing method comprising:
with respect to a recording and reproducing system comprising: a recording device having an optical disk drive unit or a hard disk drive unit configured to record content information, and a communication function;
a power supply device having a relay unit configured to relay a signal from the recording device, a converting unit configured to convert an alternate current to supply a direct current, and a switch unit configured to generate an instruction signal for instructing acquisition of content information; and
a portable recording and reproducing apparatus having a main body to be stored in the power supply device detachably, the portable recording and reproducing apparatus including: a power supply unit configured to receive the direct current from the converting unit of the power supply device and charge a built-in battery with the direct current to supply electricity to respective units; an input unit configured to receive the instruction signal supplied from the switch unit of the power supply device; a recording unit configured to record the content information in a recording area; and a communication unit configured to communicate with the recording unit by relaying through the relay unit of the power supply device so as to acquire the content information,
controlling, when the portable recording and reproducing apparatus receives the instruction signal from the input unit, to request to transfer content information by communicating with the recording device through the communication unit and the relay unit, acquire the content information, record the content information, and read out and reproduce the content information.
